(19) United States
(12) Patent Application Publication
(10) Pub. No.: US 2008/0171819 A1
(43) Pub. Date: Jul. 17, 2008

(54) Antistatically Finished Polymer Compositions, The Preparation and Use Thereof

(76) Inventors: Stefan Fokken, Biberbach (DE); Hans-Jurgen Sander, Lorsch (DE)

Correspondence Address: ALSTON & BIRD LLP, BANK OF AMERICA PLAZA, 101 SOUTH TRYON STREET, SUITE 4000, CHARLOTTE, NC, 28280-4000, US

(21) Appl. No.: 11/721,948

(22) PCT Filed: Dec. 16, 2005
(86) PCT No.: PCT/EP2005/013608

§ 371 Date: Aug. 31, 2007

(30) Foreign Application Priority Data
Dec. 17, 2004 (DE) 102004060928.4

(51) Int. Cl. C08K 5/17

(52) U.S. Cl. 524/236

(57) ABSTRACT

The invention is a polymer composition and a method of preparing same, wherein the polymer composition comprises at least one perchlorate and at least one organic solvent. The polymer composition is preferably for use with halogen-containing polymers.

### FIELD OF THE INVENTION

The present invention relates to an antistatically finished polymer composition, the preparation thereof and the use thereof.

### BACKGROUND OF THE INVENTION

It is known that under exposure to heat halogenated plastics tend towards undesirable decomposition and degradation reactions during processing or in long-term use. On degradation of halogenated polymers, in particular PVC, hydrochloric acid is formed, which is eliminated from the polymer strand, resulting in a discoloured, unsaturated plastic having colour-imparting polyene sequences. A particular problem in this context is that halogenated polymers have the theological framework conditions necessary for processing only at a relatively high processing temperature. At such temperatures, however, a noticeable decomposition of the polymer already starts in non-stabilized polymers, leading both to the undesirable change in colour described above and to a change in the properties of the material. Furthermore, the hydrochloric acid released from non-stabilized, halogenated polymers at such a processing temperature can lead to a noticeable corrosion of the processing installations. This process plays a role in particular if interruptions in production occur during the processing of such halogenated polymers to shaped articles, for example by extrusion, and the polymer melt remains in the extruder for a relatively long period of time. During this period, the abovementioned decomposition reactions may occur, as a result of which the batch in the extruder becomes unusable, and the extruder may be damaged.

Polymers which are subjected to such a decompositions furthermore tend to form adhesions on the processing installations, which can be removed again only with difficulty.

To solve the problems mentioned, compounds which are intended to prevent the abovementioned decomposition reactions to the greatest possible extent are conventionally added as so-called stabilizers to halogenated polymers for the processing. As a rule, such stabilizers are solids, which are added to the polymers to be processed before its processing.

A further problem in the production and use of shaped articles from halogenated polymers is that the shaped articles can have electrostatically unfavourable properties. In order to counteract these adverse properties, antistatics are therefore often added to the polymers. The tendency of polymers to become charged during exposure to mechanical stresses, in particular during friction, is counteracted or rapid draining of the charge is ensured with the aid of such antistatics.

Carbon blacks, PEG esters, glycerol mono- or distearate or, for example, also inorganic perchlorate compounds are therefore often added to polymers as antistatics. While the compounds mentioned first have often left something to be desired in respect of their antistatic action, perchlorates were conventionally envisaged for use in polymer compositions which serve to stabilize plastics.

Needless to say, in this context adverse combinations of stabilizing and antistatic properties result for a large number of fields of use.

### SUMMARY OF THE INVENTION

The present invention was therefore based on the object of providing a polymer composition which leads to an improvement in the discharge properties. The present invention was furthermore based on the object of providing a polymer composition which shows suitable discharge properties of the polymeric end product and shows only a slight or no clouding in transparent end products, for example of rigid or plasticized PVC. The invention was furthermore based on the object of providing a polymer composition which on the one hand imparts good discharge characteristics to the end product and moreover has a better heat stability.

It has now been found that polymer compositions which contain at least a mixture of an organic ammonium perchlorate and an aminoalkanol achieve the abovementioned objects.

The invention therefore firstly provides a polymer composition which comprises the following components:
a) at least one halogenated polymer,
b) at least one organic ammonium salt of a perchlorate or a mixture of two or more organic ammonium salts of perchlorates and
c) at least one amino alcohol having 2 to 12 C atoms in the alcohol radical, the melting point of the amino alcohol being 80° C. or less.

### DETAILED DESCRIPTION OF THE INVENTION

In the context of the present invention, a “polymer composition” is understood as meaning a composition which contains at least one stabilizer composition which is suitable for stabilizing halogenated polymers and moreover has a positive influence on the discharge properties of these halogenated polymers To achieve this stabilizing and discharge effect, an appropriate stabilizer composition is as a rule mixed with a halogenated polymer intended for stabilization and the mixture is then processed to a polymer composition. However, it is equally possible to admix a stabilizer composition to the halogenated polymer to be stabilized during processing thereof. In both cases, the improved discharge characteristics occur from the addition onwards, and continue to act in the processed polymer.

In the context of the present invention, the term “liquid” is understood as meaning the state of aggregation of a stabilizer composition according to the invention at least over a temperature range of from about 45 to 100° C., preferably over a temperature range of from about 30 to about 120° C., further preferably over a temperature range of from about 15 to about 150° C. or further preferably over a temperature range of from about 0 to about 200° C.

According to the present invention, an “ammonium salt” is an organic ammonium salt. This means that the ammonium group of the onium salt carries at least one organic radical. In this context, an ammonium salt according to the present invention can carry 1, 2, 3 or 4 organic radicals, depending on the nature of the ammonium group.

An ammonium perchlorate which can be employed in the context of the present invention contains at least one positively charged N atom or two or more such positively charged N atoms.

In the context of the present invention, compounds which carry on the N atom at least one organic radical and at most the maximum possible number of organic radicals are employed as ammonium perchlorates. If an ammonium perchlorate which can be employed according to the invention carries fewer organic radicals than are necessary for formation of a positively charged ammonium ion, the positive charge is generated in the conventional manner known to the person skilled in the art by protonation by means of a suitable acid, so that in this case the corresponding ammonium perchlorate also carries at least one proton in addition to an organic radical.

According to the invention, compounds which have a positive charge due to protonation reactions can therefore thus be employed as ammonium perchlorates. However, in the context of the polymer compositions according to the invention, it is equally possible to employ ammonium perchlorates which have a positive charge due to a peralkylation reaction. Examples of such compounds are tetraalkylammonium perchlorates. However, it is equally provided in the context of the present invention for a peralkylated ammonium perchlorate which can be employed according to the invention to contain an aryl, alkaryl, cycloalkyl, alkenyl, alkynyl or cycloalkenyl radical. It is equally possible and provided according to the invention for an ammonium salt which can be employed in the context of a polymer composition according to the invention to contain two or optionally more different types of substituents, for example an alkyl and a cycloalkyl radical or an alkyl and an aryl radical.

It is equally possible and provided in the context of the present invention for an ammonium salt which can be employed in the context of a polymer composition according to the invention to contain substituents which in their turn are substituted by one or more functional groups. In this context, groups which improve or at least do not or only insignificantly impair the properties of the polymer composition in respect of antistatic properties and stabilization to heat during processing or in long-term use are called “functional groups”. Corresponding functional groups can be, for example, NH groups, NH₂ groups, OH groups, SH groups, ester groups, ether groups, thioether groups, isocyanurate groups or keto groups or mixtures of two or more of these.

In this context, ammonium perchlorates which can be employed are in principle all compounds which lead to an ammonium perchlorate by appropriate reaction of suitable reactants. In this context, ammonium perchlorates which can be employed according to the invention can be obtained, for example, by appropriate reaction of amines or amides, such as alkylmonoamines, alkylenediamines, alkylpolyamines, secondary or tertiary amines or dialkylamines. Suitable ammonium perchlorates are therefore derived, for example, from primary mono- or polyamino compounds having 2 to about 40, for example 6 to about 20 C atoms. These are, for example, ethylamine, n-propylamine, i-propylamine, n-butylamine, sec-butylamine, tert-butylamine and substituted amines having 2 to about 20 C atoms, such as 2-(N,N-dimethylamino)-1-aminoethane.

Suitable diamines contain, for example, two primary, two secondary, two tertiary or one primary and one secondary or one primary and one tertiary or one secondary and one tertiary amino group. Examples of these are diaminoethane, the isomeric diaminopropanes, the isomeric diaminobutanes, the isomeric diaminohexanes, piperazine, 2,5-dimethylpiperazine, amino-3-aminomethyl-3,5,5-trimethylcyclohexane (isophoronediamine, IPDA), 4,4′-diaminodicyclohexylmethane, 1,4-diaminocyclohexane, aminoethylethanolamine, hydrazine, hydrazine hydrate or triamines, such as diethylenetriamine or 1,8-diamino-4-aminomethyloctane, or tertiary amines, such as triethylamine, tributylamine, dimethyl-benzylamine, N-ethyl-, N-methyl-, N-cyclohexylmorpholine, dimethylcyclohexylamine, dimorpholinodiethyl ether, 1,4-diazabicyclo[2,2,2]octane, 1-azabicyclo[3,3,0]octane, N,N,N′,N′-tetramethylethylenediamine, N,N,N′,N′-tetramethylbutanediamine, N,N,N′,N′-tetramethylhexane-1,6-diamine, pentamethyldiethylenetriamine, tetramethyldiaminoethyl ether, bis-(dimethylaminopropyl)-urea, N,N′-dimethylpiperazine, 1,2-dimethylimidazole or di-(4-N,N-dimethylaminocyclohexyl)-methane.

In the context of a further embodiment of the present invention, triethylammonium perchlorate or triisopropylammonium perchlorate or a mixture thereof is employed as the ammonium perchlorate.

In some cases it has emerged as advantageous if at least one alkyl radical of an ammonium perchlorate employed according to the invention contains a polar substituent. In this context, all polar substituents which, in the context of the “functional groups” already mentioned above, improve or at least do not or only insignificantly impair the properties of the polymer composition in respect of antistatic properties and stabilization to heat during processing or in long-term use are in principle suitable. Corresponding polar substituents can be, for example, NH groups, NH₂ groups, OH groups, SH groups, ester groups, ether groups, thioether groups, isocyanurate groups or keto groups or mixtures of two or more of these. In the context of a further embodiment of the present invention, ammonium perchlorates which contain at least one OH group are employed as a constituent of a polymer composition according to the invention.

Aliphatic amino alcohols having 2 to about 40, preferably 6 to about 20 C atoms, for example ethanolamine, propanolamine, butanolamine, diethanolamine, dipropanolamine, dibutanolamine, triethanolamine, tripropanolamine, tributanolamine, tripentanolamine, 1-amino-3,3-dimethyl-pentan-5-ol, 2-aminohexane-2′,2″-diethanolamine, 1-amino-2,5-di-methylcyclohexan-4-ol, 2-aminopropanol, 2-aminobutanol, 3-aminopropanol, 1-amino-2-propanol, 2-amino-2-methyl-1-propanol, 5-aminopentanol, 3-aminomethyl-3,5,5-trimethyl-cyclohexanol, 1-amino-1-cyclopentane-methanol, 2-amino-2-ethyl-1,3-propanediol, 2-(di-methylaminoethoxy)-ethanol, aromatic-aliphatic or aromatic-cycloaliphatic amino alcohols having 6 to about 20 C atoms, where heterocyclic or isocyclic ring systems, such as naphthalene or, in particular, benzene derivatives, such as 2-aminobenzyl alcohol, 3-(hydroxymethyl)aniline, 2-amino-3-phenyl-1-propanol, 2-amino-1-phenylethanol, 2-phenyl-glycinol or 2-amino-1-phenyl-1,3-propanediol and mixtures of two or more such compounds are employed as aromatic structures, are suitable, for example, for the preparation of such ammonium perchlorates.

In the context of a further embodiment of the present invention, the perchlorates of heterocyclic compounds which have a cyclic ring system containing amino groups are employed as ammonium perchlorates.

For example, the perchlorates of heterocyclic amino alcohols which contain at least 2, preferably at least 3 amino groups in the ring are employed in this context. The trimerization products of isocyanates are particularly suitable here as the central ring constituent of the ammonium perchlorates which can be employed according to the invention.

Suitable compounds in this context are, for example, isocyanurates containing hydroxyl groups, of the general formula I

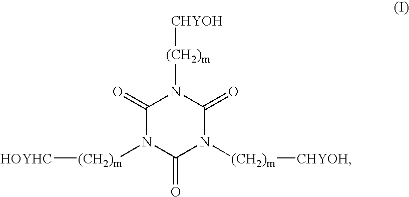

wherein the groups Y and the indices m are in each case identical or different and m represents an integer from 0 to 20 and Y represents a hydrogen atom or a linear or branched, saturated or unsaturated alkyl group having 1 to about 10 C atoms. In the context of the present invention, the use of tris(hydroxymethyl) isocyanurate (THEIC) as a constituent of the stabilizer compositions according to the invention is particularly preferred.

Compounds in which the amino group is bonded to a substituted aromatic or heteroaromatic system, for example aminobenzoic acid, aminosalicylic acid or aminopyridinecarboxylic acid and suitable derivatives thereof, are likewise suitable, for example, as ammonium perchlorates.

In the context of a further embodiment of the present invention, 2-ethylcarboxypyridinium perchlorate, formamidinium perchlorate, the perchlorate salt of trishydroxyethyl isocyanurate, the perchlorate salt of 2-(diethylamino)-ethanol, N-(2-hydroxyethyl)-morpholinium perchlorate or trioctylammonium perchlorate or mixtures of two or more of these are employed, for example, as ammonium perchlorates.

In the context of the present invention, a polymer composition according to the invention can contain, for example, only one of the abovementioned ammonium perchlorates. However, it is equally possible and also provided in the context of the present invention for a polymer composition according to the invention to contain a mixture of two or more of the abovementioned ammonium perchlorates. This can be a mixture of two or more different types of ammonium perchlorates.

If a polymer composition according to the invention contains a mixture of two or more ammonium perchlorates, these two or more ammonium perchlorates can be present in the polymer composition according to the invention in principle in any desired ratio. It is preferable for at least one ammonium perchlorate to contain at least one alkyl radical having a polar substituent, for example an OH group. In this context, it is very particular preferable for such an ammonium perchlorate to make up the largest proportion by amount of the ammonium perchlorates present in a polymer composition according to the invention.

In the context of the present invention, a polymer composition according to the invention contains, based on the total composition, 0.01 to about 5 wt. %, for example about 0.05 to about 3 wt. % of an organic ammonium salt of a perchlorate or of a mixture of two or more organic ammonium salts of perchlorates.

A polymer composition according to the invention also contains, in addition to an ammonium perchlorate or a mixture of two or more ammonium perchlorates, at least one amino alcohol having 2 to 12 C atoms in the alcohol radical, the melting point of the amino alcohol being 80° C. or less.

In the context of the present invention, it has been found that the use of amino alcohols having a carbon chain length in the alcohol radical in the range of 2-12 C atoms advantageously modifies the properties of a polymer composition according to the invention in an unforeseeable manner to the extent that both the processing properties in respect of heat stability and the use properties in respect of the fastest possible discharges of an object in use which can be produced from a polymer composition according to the invention can be equally improved.

In this context, the alcohol radical can in principle contain an aliphatic, cycloaliphatic or aromatic matrix. If an amino alcohol present according to the invention contains two or more alcohol radicals, the corresponding alcohol radicals can be for example, exclusively aliphatic or exclusively cycloaliphatic or exclusively aromatic in structure. However, it is equally possible according to the invention for corresponding alcohol radicals to be mixed in structure. It is thus possible, for example, for an amino alcohol which can be employed in the context of the present invention to contain a mixture of aliphatic and cycloaliphatic or a mixture of aliphatic and aromatic or a mixture of cycloaliphatic and aromatic alcohol radicals. If an amino alcohol which can be employed according to the invention has three alcohol radicals, these can be, for example, aliphatic, cycloaliphatic and aromatic in structure. If one alcohol radical is an aliphatic alcohol radical, this can be linear or branched and saturated or unsaturated, but preferably saturated. Cycloaliphatic and aromatic alcohol radicals can be mono- or polycyclic in structures and optionally contain substituents, such as alkyl groups, halogens or, in addition to an OH group present or in addition to the OH groups present, other polar substituents

Suitable amino alcohols contain alcohol radicals which have 2 to about 12 carbon atoms. Amino alcohols with alcohol radicals having 2, 3, 4, 5, 6, 7, 8, 9, 10 or 11 carbon atoms, for example having 2 to about 8 or 3 to about 6 carbon atoms, for example, are suitable.

It has furthermore emerged, according to the invention, that a combination of a perchlorate and an amino alcohol having a number of from two to 12 carbon atoms in the alcohol radical and a melting point of less than 80° C. allows an excellent distribution of the active compounds within the polymer during processing of a polymer composition according to the invention, so that an unexpected increase in the antistatic action together with an improvement in the heat stabilization is achieved.

Suitable amino alcohols can have, for example, a melting point of up to about 70 or up to about 60 or up to about 50° C. Amino alcohols having a melting point below these values, for example amino alcohols having a melting point of up to about 40, up to about 30, up to about 20 or up to about 10° C. or less, for example up to about 0, up to about −10 or up to about −20° C., are equally suitable in the context of the present invention.

In the context of the present invention, it has emerged that it is advantageous if a polymer composition according to the invention contains at least one amino alcohol which is an alkanolamine. Suitable amino alcohols are in principle amino monoalcohols or amino dialcohols or amino trialcohols or mixtures of two or more of these, wherein a polymer composition according to the invention can contain, for example, an amino monoalcohol or amino dialcohol or amino trialcohol or a mixture of two or more of these.

All amino alcohols which meet the abovementioned conditions in respect of the number of carbon atoms in the alcohol radical and of the melting point are in principle suitable in the context of the present invention. However, it has been found in the present case that in some cases particularly advantageous actions can be achieved if the amino alcohol is a mono-amino alcohol.

Suitable alkanolamines are, for example, ethanolamine, propanolamine, butanolamine, diethanolamine, dipropanolamine, dibutanolamine, triethanolamine, tri-n-propanolamine, triisopropanolamine, tributanolamine, tripentanolamine, 1-amino-3,3-dimethyl-pentan-5-ol, 2-aminohexane-2′,2″-diethanolamine, 1-amino-2,5-dimethylcyclohexan-4-ol, 2-aminopropanol, 2-aminobutanol, 3-aminopropanol, 1-amino-2-propanol, 2-amino-2-methyl-1-propanol, 5-aminopentanol, 3-aminomethyl-3,5,5-trimethylcyclohexanol, 1-amino-1-cyclopentane-methanol, 2-amino-2-ethyl-1,3-propanediol, 2-(dimethylaminoethoxy)-ethanol, aromatic-aliphatic or aromatic-cycloaliphatic amino alcohols having 6 to about 20 C atoms, where heterocyclic or isocyclic ring systems, such as naphthalene or, in particular, benzene derivatives, such as 2-amino-1-phenylethanol, 2-phenylglycinol or 2-amino-1-phenyl-1,3-propanediol and mixtures of two or more such compounds are employed as aromatic structures.

A composition according to the invention contains the abovementioned organic ammonium perchlorates and the abovementioned amino alcohols, for example, in a ratio of from about 100:1 to about 1:100. In the context of the present invention, it is particularly advantageous if the content of amino alcohol is only slightly lower than the content of organic perchlorate, for example is as high as the content of organic perchlorate or even slightly or significantly exceeds this content. This is reflected, for example, in suitable ratios of ammonium perchlorate to amino alcohol of from about 2:1 to about 1:30 or about 1.5:1 to about 1:20 or about 1:1 to about 1:10.

A polymer composition according to the invention can moreover furthermore contain one or more solvents.

In the context of the present invention, a “solvent” is understood as meaning a compound or a mixture of two or more compounds which is liquid within a certain temperature range and is capable of dissolving an ammonium perchlorate present in a composition according to the invention or a mixture of two or more such ammonium perchlorates. A solvent which is suitable in the context of the present invention is liquid at least within a temperature range of from about 45 to about 100° C., preferably within a temperature range of from about 30 to about 120° C. or within a temperature range of from about 15 to about 150° C. and in particular within a temperature range of from about 0 to about 200° C. In this context, in the context of the present text the expression “within a temperature range of from” refers to the state of aggregation of the solvent within the entire temperature range. This means, for example, that a solvent which is to be liquid within a temperature range of from about 0 to about 200° C. has this state of aggregation over the entire temperature range mentioned, that is to say has a melting point of less than 0° C. and a boiling point of more than 200° C.

In the context of a preferred embodiment of the present invention, compounds or mixtures of two or more compounds which are suitable as plasticizers for halogenated polymers are employed as solvents.

Suitable solvents in the context of the present text are therefore, for example, compounds from the group consisting of phthalic acid esters, such as dimethyl, diethyl, dibutyl, dihexyl, di-2-ethylhexyl, di-n-octyl, di-iso-octyl, di-iso-nonyl, di-iso-decyl, dicyclohexyl, di-methylcyclohexyl, dimethylglycol, dibutylglycol, benzyl butyl or diphenyl phthalate and mixtures of phthalates, for example mixtures of alkyl phthalates having 7 to 9 or 9 to 11 C atoms in the ester alcohol or mixtures of alkyl phthalates having 6 to 10 and 8 to 10 C atoms in the ester alcohol. In this context, dibutyl, dihexyl, di-2-ethylhexyl, di-n-octyl, di-iso-octyl, di-iso-nonyl, di-iso-decyl, di-iso-tridecyl and benzyl butyl phthalate and the said mixtures of alkyl phthalates are particularly suitable in the context of the present invention.

The esters of aliphatic dicarboxylic acids, in particular the esters of adipic, azelaic or sebacic acid or mixtures of two or more of these, are furthermore suitable as solvents. Examples of such solvents are di-2-ethylhexyl adipate, di-isooctyl adipate, di-iso-nonyl adipate, di-iso-decyl adipate, benzyl butyl adipate, benzyl octyl adipate, di-2-ethylhexyl azelate, di-2-ethylhexyl sebacate and di-iso-decyl sebacate. In the context of a further embodiment of the present invention, di-2-ethylhexyl acetate and di-iso-octyl adipate are preferred.

Trimellitic acid esters, such as tri-2-ethylhexyl trimellitate, tri-iso-tridecyl trimellitate, tri-iso-octyl trimellitate and trimellitic acid esters having 6 to 8, 6 to 10, 7 to 9 or 9 to 11 C atoms in the ester group or mixtures of two or more of the compounds mentioned, are likewise suitable as solvents.

Polymer plasticizers, for example, such as are mentioned in “Kunststoffadditive [Plastics Additives]”, R. Gächter/H. Müller, Carl Hanser Verlag, 3rd edition, 1989, chapter 5.9.6, pages 342-489, or “PVC Technology”, W. V. Titow, 4th edition, Elsevier Publishers, 1984, pages 165-170, are furthermore suitable solvents. Reference is herewith expressly made to the publications mentioned, and the plasticizers listed in the context of the source mentioned first (R. Gächter/H. Müller) and suitable as solvents in the context according to the invention, in particular the compounds mentioned in Tables 9a (p. 388-392), 10 (p. 396), 11 (p. 400), 12a (p. 402-404), 13a (p. 408-410), 13b (p. 412), 14 (p. 413), 16 (p. 418), 3 (p. 479) and 4 (p. 486-488), are considered to be a constituent of the disclosure of the present text.

The most usual starting materials for the preparation of polyester plasticizers are, for example, dicarboxylic acids, such as adipic, phthalic, azelaic or sebacic acid, and diols, such as 1-propanediol, 1,3-butanediol, 1,4-butanediol, 1,6-hexanediol, neopentylglycol or diethylene glycol or mixtures of two or more of these.

Phosphoric acid esters such as are to be found in “Taschenbuch der Kunststoffadditive [Handbook of Plastics Additives]”, chapter 5.9.5, p. 408-412 are likewise suitable as plasticizers. Examples of suitable phosphoric acid esters are tributyl phosphate, tri-2-ethylbutyl phosphate, tri-2-ethylhexyl phosphate, trichloroethyl phosphate, 2-ethylhexyl diphenyl phosphate, triphenyl phosphate, tricresyl phosphate or trixylenyl phosphate, or mixtures of two or more of these. In the context of a further embodiment of the present invention, a polymer composition according to the invention contains at least one phosphoric acid ester. Suitable amounts of phosphoric acid esters lie, for example, within a range of from 0.01 to about 50 wt. %.

The compounds listed in the following are particularly suitable as solvents in the context of the present invention: 2-hydroxy-5-methyl-benzoic acid methyl ester, 2-ethoxybenzyl alcohol, N-ethyl-2,3-dimethylaniline, 2-hydroxy-3-methyl-benzoic acid methyl ester, lauric acid benzyl ester, 3,4,5-trimethoxybenzyl alcohol, 3,5-dimethylbenzyl alcohol, 3-methylbenzophenone, 2-methoxyactetophenone, 3-cyclohexylpropionic acid, cyclopentane-carboxylic acid, 2,5-dimethylbenzonitrile, 4-(4-methoxyphenyl)-butan-2-one, formic acid cinnamyl ester, triethyl citrate, decanedioic acid dibutyl ester, heptaethylene glycol, decanedioic acid diethyl ester, adipic acid dibutyl ester, 1,2-bis(2-acetoxy-ethoxy)-ethane, azelaic acid diethyl ester, suberic acid diethyl ester, glutaric acid diethyl ester, myristic acid ethyl ester, oxalic acid dibutyl ester, 9-decenyl propionate, lauric acid methyl ester, acetic acid decyl ester, cyanoacetic acid butyl ester, hexanoic acid pentyl ester, acetic acid nonyl ester, decanoic acid methyl ester, nonanoic acid methyl ester, undecylene alcohol, N-methyldioctylamine, diethylene glycol dibutyl ether, dioctyl ether, decan-3-one, 4-oxa-heptanedinitrile, nonanenitrile, diethylene glycol monohexyl ether, diisobutyl ketone, formic acid butyl ester, n-tridecyl alcohol, butyl carbitol, glutaric acid dinitrile, propionic acid methyl ester, thioformic acid dimethylamide, octamethylenedimercaptan, 2-ethylhexane-1,3-diol, decan-4-ol, decane-1-thiol, hexamethylenedimercaptan, dodecan-2-ol, N-butylformamide, diisopentyl sulfide, hexaethylene glycol, pentaethylene glycol, trioctylamine, dipropylenetriamine, triethylene glycol, dodecylmercaptan, 2,2′-dithiodiglycol, diethyl carbonate, m-tolyl isothiocyanate, linolenic acid, triethylenetetramine, 5H-furan-2-one, 4-benzylpiperidine, 1-phenylpiperidine, isonicotinic acid ethyl ester, pyridine-2-carboxylic acid ethyl ester, 2,3,3-trimethyl-3H-indole, 3-methylsulfolane, propylene carbonate, 3-piperidinopropionitrile, sulfolane, tetrahydrothiophene 1-oxide, 4-morpholinoethanol or 4-octylaniline.

The abovementioned solvents can be present in a polymer composition according to the invention in each case by themselves or as a mixture of two or more of these. If a polymer composition according to the invention is a liquid polymer composition which contains two or more of the abovementioned compounds as solvents, one of the compounds or several of the compounds can lie outside the abovementioned definition of the term “liquid”, as long as the total solvent mixture lies within this definition.

A polymer composition according to the invention contains the solvent or solvent mixture in an amount of from about 0.01 to about 50 percent by weight.

In addition to an ammonium perchlorate or a mixture of two or more ammonium perchlorates or an ammonium perchlorate or a mixture of two or more ammonium perchlorates and an amino alcohol or a mixture of two or more amino alcohols, as mentioned above, and optionally a solvent or a mixture of two or more solvents, a polymer composition according to the invention can also contain one or more further additives in an amount of up to about 70 wt. %.

Additives which are suitable in principle for use in a polymer composition according to the invention, by themselves or as a mixture of two or more of these, are listed in the context of the present text in the following.

Compounds which are suitable as additives in the context of the present invention are the aminouracil compounds of the general formula II

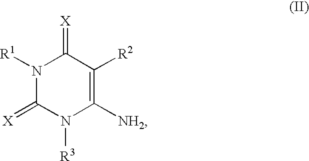

wherein the radicals R¹ and R² in each case independently of one another represent hydrogen, an optionally substituted linear or branched, saturated or unsaturated, aliphatic alkyl radical having 1 to 44 C atoms, an optionally substituted, saturated or unsaturated cycloalkyl radical having 6 to 44 C atoms or an optionally substituted aryl radical having 6 to 44 C atoms or an optionally substituted aralkyl radical having 7 to 44 C atoms, or the radical R¹ represents an optionally substituted acyl radical having 2 to 44 C atoms, and the radical R³ represents hydrogen, an optionally substituted linear or branched, saturated or unsaturated aliphatic hydrocarbon radical having 1 to 44 C atoms, an optionally substituted saturated or unsaturated cycloaliphatic hydrocarbon radical having 6 to 44 C atoms or an optionally substituted aromatic hydrocarbon radical having 6 to 44 C atoms.

Compounds which are moreover suitable generally as additives are compounds having a structural element of the general formula III

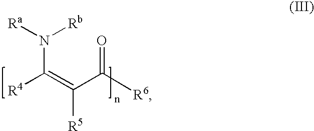

wherein n represents a number from 1 to 100,000, the radicals R^{a}, R^{b}, R⁴ and R⁵ in each case independently of one another represent hydrogen, an optionally substituted linear or branched, saturated or unsaturated aliphatic alkyl radical having 1 to 44 C atoms, an optionally substituted saturated or unsaturated cycloalkyl radical having 6 to 44 C atoms or an optionally substituted aryl radical having 6 to 44 C atoms or an optionally substituted aralkyl radical having 7 to 44 C atoms, or the radical R⁴ represents an optionally substituted acyl radical having 2 to 44 C atoms, or the radicals R⁴ and R⁵ are bonded to form an aromatic or heterocyclic system, and wherein the radical R⁶ represents hydrogen, an optionally substituted, linear or branched, saturated or unsaturated aliphatic alkyl or alkylene radical or oxyalkyl or oxyalkylene radical or mercaptoalkyl or mercaptoalkylene radical or aminoalkyl or aminoalkylene radical having 1 to 44 C atoms, an optionally substituted saturated or unsaturated cycloalkyl or cycloalkylene radical or oxycycloalkyl or oxycycloalkylene radical or mercaptocycloalkyl or mercaptocycloalkylene radical or aminocycloalkyl or aminocycloalkylene radical having 6 to 44 C atoms or an optionally substituted aryl or arylene radical having 6 to 44 C atoms or an ether or thioether radical having 1 to 20 O or S atoms or O and S atoms, or represents a polymer which is bonded to the structural element in parentheses via O, S, NH, NR^{a} or CH₂C(O), or the radical R⁶ is bonded to the radical R⁴ such that an optionally substituted, saturated or unsaturated heterocyclic ring system having 4 to 24 C atoms is formed in total.

In the context of a preferred embodiment of the present invention, a compound based on an α,β-unsaturated β-aminocarboxylic acid, in particular a compound based on β-aminocrotonic acid, is employed as a compound of the general formula III. The esters or thioesters of the corresponding aminocarboxylic acids with monofunctional or polyfunctional alcohols or mercaptans, wherein X in the cases mentioned in each case represents O or S, are particularly suitable here.

If the radical R⁶ together with X represents an alcohol or mercaptan radical, such a radical can be formed, for example, from methanol, ethanol, propanol, isopropanol, butanol, 2-ethylhexanol, isooctanol, isononanol, decanol, lauryl alcohol, myristyl alcohol, palmityl alcohol, stearyl alcohol, ethylene glycol, propylene glycol, 1,3-butanediol, 1,4-butanediol, 1,6-hexanediol, 1,10-decanediol, diethylene glycol, thiodiethanol, trimethylolpropane, glycerol, tris-(2-hydroxymethyl) isocyanurate, triethanolamine, pentaerythritol, di-trimethylolpropane, diglycerol, sorbitol, mannitol, xylitol, di-pentaerythritol and the corresponding mercapto derivatives of the alcohols mentioned.

In the context of a particularly preferred embodiment of the present invention, a compound in which R⁴ represents a linear alkyl radical having 1 to 4 C atoms, R⁵ represents hydrogen and R⁶ represents a linear or branched, saturated, mono- to hexavalent alkyl or alkylene radical having 2 to 12 C atoms or a linear, branched or cyclic, 2- to 6-valent ether-alcohol radical or thioether-alcohol radical is employed as a compound of the general formula III.

Suitable compounds of the general formula III include, for example, β-aminocrotonic acid stearyl ester, 1,4-butanediol di(β-aminocrotonic acid) ester, thiodiethanol β-aminocrotonic acid ester, trimethylolpropane tri-β-aminocrotonic acid ester, pentaerythritol tetra-β-aminocrotonic acid ester, dipentaerythritol hexa-β-aminocrotonic acid ester and the like. The compounds mentioned can be contained in a polymer composition according to the invention in each case by themselves or as a mixture of two or more of these.

Compounds in which the radicals R⁴ and R⁵ are bonded to form an aromatic or heteroaromatic system, for example aminobenzoic acid, aminosalicylic acid or aminopyridinecarboxylic acid and suitable derivatives thereof, are likewise suitable, for example, as compounds of the general formula III.

Compounds which contain a mercapto-functional sp²-hybridized C atom, carbazoles, carbazole derivatives or 2,4-pyrrolidinedione or 2,4-pyrrolidinedione derivatives are suitable, for example, as further additives.

In the context of the present invention, suitable compounds which contain at least one mercapto-functional, sp²-hybridized C atom are in principle all compounds which contain a structural element Z=CZ-SH or a structural element Z₂C═S, wherein both structural elements can be tautomeric forms of a single compound. In this context, Z in principle represents any desired structural element which is capable of forming a corresponding tautomeric compound, that is to say at least one displaceable H atom. In this context, the sp²-hybridized C atom can be a constituent of an optionally substituted aliphatic compound or a constituent of an aromatic system. Suitable compound types are, for example, thiocarbamic acid derivatives, thiocarbamates, thiocarboxylic acids, thiobenzoic acid derivatives, thioacetone derivatives or thiourea or thiourea derivatives.

In the context of a further embodiment of the present invention, thiourea or a thiourea derivative is employed as an additive having at least one mercapto-functional, sp²-hybridized C atom.

Epoxide compounds, for example, are likewise suitable as additives. Examples of such epoxide compounds are epoxidized soya oil, epoxidized olive oil, epoxidized linseed oil, epoxidized castor oil, epoxidized groundnut oil, epoxidized maize oil, epoxidized cottonseed oil and glycidyl compounds.

Particularly suitable epoxide compounds are described, for example, in EP-A 1 046 668 on pages 3 to 5, reference being expressly made to the disclosure contained there, which is regarded as a constituent of the disclosure of the present text.

1,3-Dicarbonyl compounds, in particular the β-diketones and β-keto esters, are furthermore suitable as additives in the context of the present invention. Dicarbonyl compounds of the general formula R′C(O)CHR″—C(O)R′″, such as are described, for example, on p. 5 of EP-1 046 668, to which reference is expressly made in particular in respect of the radicals R′, R″ and R′″, and the disclosure of which is regarded as a constituent of the disclosure of the present text, are suitable in the context of the present invention. Compounds which are particularly suitable here are, for example, acetylacetone, butanoylacetone, heptanoylacetone, stearoylacetone, palmitoylacetone, lauroylacetone, 7-tert-nonylthioheptane-2,4-dione, benzoylacetone, dibenzoylmethane, lauroylbenzoylmethane, palmitoylbenzoylmethane, stearoylbenzoylmethane, isooctylbenzoylmethane, 5-hydroxycaproylbenzoylmethane, tribenzoylmethane, bis(4-methylbenzoyl)methane, benzoyl-p-chlorobenzoylmethane, bis(2-hydroxybenzoyl)methane, 4-methoxybenzoylbenzoylmethane, bis(4-methoxybenzoyl)methane, benzoylformylmethane, benzoylacetylphenylmethane, 1-benzoyl-1-acetylnonane, stearoyl-4-methoxybenzoylmethane, bis(4-tert-butylbenzoyl)methane, benzoylphenylacetylmethane, bis(cyclohexanoyl)methane, dipivaloylmethane, 2-acetylcyclopentanone, 2-benzoylcyclopentanone, diacetoacetic acid methyl, ethyl, butyl, 2-ethylhexyl, dodecyl or octadecyl ester and propionyl- or butyrylacetic acid esters having 1 to 18 C atoms, as well as stearoylacetic acid ethyl, propyl, butyl, hexyl or octyl ester, or polynuclear β-keto esters such as are described in EP-A 433 230, to which reference is expressly made, or dehydracetic acid and zinc, magnesium or alkali metal salts thereof or the alkali metal, alkaline earth metal or zinc chelates of the compounds mentioned, where these exist and are soluble in the polymer compositions according to the invention or are miscible with these to achieve the abovementioned results.

1,3-Diketo compounds can be contained in a polymer composition according to the invention in an amount of up to about 20 wt. %, for example up to about 10 wt. %.

Polyols are furthermore suitable as additives in the context of the polymer composition according to the invention. Suitable polyols are, for example, pentaerythritol, dipentaerythritol, tripentaerythritol, bistrimethylolpropane, inositol, polyvinyl alcohol, bistrimethylolethane, trimethylolpropane, sorbitol, maltitol, isomaltitol, lactitol, Lycasin, mannitol, lactose, leucrose, tris-(hydroxymethyl) isocyanurate, palatinitol, tetramethylolcyclohexanol, tetramethylolcyclopentanol, tetramethylolcycloheptanol, glycerol, diglycerol, polyglycerol, thiodiglycerol or 1-O-α-D-glycopyranosyl-D-mannitol dihydrate.

The polyols which are suitable as additives can be contained in a polymer composition according to the invention in an amount of up to about 30 wt. %, for example up to about 10 wt. %.

Sterically hindered amines, for example, such as are mentioned in EP-A 1 046 668 on pages 7 to 27 are likewise suitable as additives. Reference is expressly made to the sterically hindered amines disclosed there, and the compounds mentioned there are regarded as a constituent of the disclosure of the present text.

The sterically hindered amines which are suitable as additives can be contained in a polymer composition according to the invention in an amount of up to about 30 wt. %, for example up to about 10 wt. %.

A polymer composition according to the invention can moreover furthermore contain an organotin compound or a mixture of two or more organotin compounds as an additive. Suitable organotin compounds are, for example, methyltin tris-(isooctyl-thioglycolate), methyltin tris-(isooctyl-3-mercaptopropionate), methyltin tris-(isodecyl-thioglycolate), dimethyltin bis-(isooctyl-thioglycolate), dibutyltin bis-(isooctyl-thioglycolate), monobutyltin tris-(isooctyl-thioglycolate), dioctyltin bis-(isooctyl-thioglycolate), monooctyltin tris-(isooctyl-thioglycolate) or dimethyltin bis-(2-ethylhexyl-β-mercaptopropionate).

In the context of the polymer composition according to the invention, the organotin compounds mentioned and described in their preparation in EP-A 0 742 259 on pages 18 to 29 can furthermore be employed. Reference is expressly made to the abovementioned disclosure, the compounds mentioned there and the preparation thereof being understood as a constituent of the disclosure of the present text.

A polymer composition according to the invention can contain the organotin compounds described in an amount of up to about 40 wt. %, in particular up to about 20 wt. %.

In the context of a further embodiment of the present invention, a polymer composition according to the invention can contain organic phosphite esters having 1 to 3 identical, pairs of identical or different organic radicals. Suitable organic radicals are, for example, linear or branched, saturated or unsaturated alkyl radicals having 1 to 24 C atoms, optionally substituted alkyl radicals having 6 to 20 C atoms or optionally substituted aralkyl radicals having 7 to 20 C atoms. Examples of suitable organic phosphite esters are tris-(nonylphenyl), trilauryl, tributyl, trioctyl, tridecyl, tridodecyl, triphenyl, octyl diphenyl, dioctyl phenyl, tri-(octylphenyl), tribenzyl, butyl dicresyl, octyl di-(octylphenyl), tris-(2-ethylhexyl), tritolyl, tris-(2-cyclohexylphenyl), tri-α-naphthyl, tris-(phenylphenyl), tris-(2-phenylethyl), tris-(dimethylphenyl), tricresyl or tris-(p-nonylphenyl) phosphite or tristearyl-sorbitol triphosphite or mixtures of two or more of these.

A polymer composition according to the invention can contain the phosphite compounds described in an amount of up to about 30 wt. %, in particular up to about 10 wt. %.

A polymer composition according to the invention can furthermore contain as additives blocked mercaptans such as are mentioned in EP-A 0 742 259 on pages 4 to 18. Reference is expressly made to the disclosure in the specification mentioned, which is understood as a constituent of the disclosure of the present text.

A polymer composition according to the invention can contain the blocked mercaptans described in an amount of up to about 30 wt. %, in particular up to about 10 wt. %.

A polymer composition according to the invention can furthermore contain lubricants, such as montan wax, fatty acid esters, purified or hydrogenated natural or synthetic triglycerides or partial esters, polyethylene waxes, amide waxes, chloroparaffins, glycerol esters or alkaline earth metal soaps, where these lubricants do not fall under the term “solvent” in the context of the present text. Lubricants which can be used as additives are furthermore also described in “Kunststoffadditive [Plastics Additives]”, R. Gächter/H. Müller, Carl Hanser Verlag, 3rd edition, 1989, p. 478-488. Fatty ketones such as are described in DE 4,204,887 and lubricants based on silicone, such as are mentioned, for example, in EP-A 0 259 783, or combinations thereof, such as are mentioned in EP-A 0 259 783, are furthermore suitable as additives. Reference is expressly made herewith to the documents mentioned, the disclosure thereof relating to lubricants being regarded as a constituent of the disclosure of the present text.

A polymer composition according to the invention can contain the lubricants described in an amount of up to about 70 wt. %, in particular up to about 40 wt. %.

Organic plasticizers are likewise suitable according to the invention as additives for the polymer composition where these plasticizers do not already fall under the term “solvent” in the context of the present text.

Suitable plasticizers are, for example, polymer plasticizers such as are mentioned in “Kunststoffadditive [Plastics Additives]”, R. Gächter/H. Müller, Carl Hanser Verlag, 3rd edition, 1989, chapter 5.9.6, pages 412-415, or “PVC Technology”, W. V. Titow, 4th edition, Elsevier Publishers, 1984, pages 165-170. The most usual starting materials for the preparation of polyester plasticizers are, for example, dicarboxylic acids, such as adipic, phthalic, azelaic or sebacic acid, and diols, such as 1,2-propanediol, 1,3-butanediol, 1,4-butanediol, 1,6-hexanediol, neopentylglycol or diethylene glycol or mixtures of two or more of these.

Phosphoric acid esters such as are to be found in “Taschenbuch der Kunststoffadditive [Handbook of Plastics Additives]”, chapter 5.9.5, p. 408-412 are likewise suitable as plasticizers. Examples of suitable phosphoric acid esters are tributyl phosphate, tri-2-ethylbutyl phosphate, tri-2-ethylhexyl phosphate, trichloroethyl phosphate, 2-ethylhexyl diphenyl phosphate, triphenyl phosphate, tricresyl phosphate or trixylenyl phosphate, or mixtures of two or more of these.

Chlorinated hydrocarbons (paraffins) or hydrocarbons such as are described in “Kunststoffadditive [Plastics Additives]”, R. Gächter/H. Müller, Carl Hanser Verlag, 3rd edition, 1989, chapter 5.9.14.2, p. 422-425 and chapter 5.9.14.1, p. 422 are furthermore suitable as plasticizers.

A polymer composition according to the invention can contain the plasticizers described in an amount of up to about 99.5 wt. %, in particular up to about 30 wt. %, up to about 20 wt. % or up to about 10 wt. %. In the context of a preferred embodiment of the present invention, the lower limit for the plasticizers described, as a constituent of the polymer compositions according to the invention, is about 0.1 wt. % or more, for example about 0.5 wt. %, 1 wt. %, 2 wt. % or 5 wt. %.

In the context of a further embodiment of the present invention, the polymer compositions according to the invention can contain antioxidants, UV absorbers or light protection agents. Suitable antioxidants are described, for example, in EP-A 1 046 668 on pages 33 to 35. Suitable UV absorbers and light protection agents are mentioned there on pages 35 and 36. Reference is expressly made here to both disclosures, the disclosures being regarded as a constituent of the present text.

A polymer composition according to the invention can also contain, in addition to a polymer and a polymer composition according to the invention, further additives which are not soluble in the polymer compositions according to the invention. All additives are in principle suitable, for example those which do not or do not substantially influence the transparency of a polymer composition prepared with the aid of such a polymer composition.

Hydrotalcites, hydrocalumites, zeolites and alkali metal alumocarbonates are furthermore suitable as additives in the polymer compositions according to the invention. Suitable hydrotalcites, hydrocalumites, zeolites and alkali metal alumocarbonates are described, for example, in EP-A 1 046 668 on pages 27 to 29, EP-A 256 872 on pages 3, 5 and 7, DE-C 41 06 411 on page 2 and 3 or DE-C 41 06 404 on page 2 and 3 or DE-C 198 60 798. Reference is expressly made to these publications, the disclosure thereof being regarded as a constituent of the disclosure of the present text.

The hydrotalcites, hydrocalumites, zeolites and alkali metal alumocarbonates which are suitable as additives can be contained in a polymer composition according to the invention in an amount of up to about 5 wt. %, for example of from 0 up to about 3 wt. %.

Metal oxides, metal hydroxides and metal soaps of saturated, unsaturated, straight-chain or branched, aromatic, cycloaliphatic or aliphatic carboxylic acids or hydroxycarboxylic acids having preferably about 2 to about 22 C atoms are likewise suitable as additives in the polymer composition according to the invention.

The metal oxides, metal hydroxides or metal soaps which are suitable as additives preferably contain as metal cations a divalent cation, and the cations of calcium or zinc or mixtures thereof are particularly suitable.

Examples of suitable carboxylic acid anions include anions of monovalent carboxylic acids, such as acetic acid, propionic acid, butyric acid, valeric acid, hexanoic acid, enanthic acid, octanoic acid, neodecanoic acid, 2-ethylhexanoic acid, pelargonic acid, decanoic acid, undecanoic acid, dodecanoic acid, tridecanoic acid, myristic acid, palmitic acid, lauric acid, isostearic acid, stearic acid, 12-hydroxystearic acid, 9,10-dihydroxystearic acid, oleic acid, 3,6-dioxaheptanoic acid, 3,6,9-trioxadecanoic acid, behenic acid, benzoic acid, p-tert-butylbenzoic acid, dimethylhydroxybenzoic acid, 3,5-di-tert-butyl-4-hydroxybenzoic acid, tolylic acid, dimethylbenzoic acid, ethylbenzoic acid, n-propylbenzoic acid, salicylic acid, p-tert-octylsalicylic acid or sorbic acid, anions of divalent carboxylic acids and monoesters thereof, such as oxalic acid, malonic acid, maleic acid, tartaric acid, cinnamic acid, mandelic acid, malic acid, glycolic acid, oxalic acid, salicylic acid, polyglycol-dicarboxylic acids having a degree of polymerization of from about 10 to about 12, phthalic acid, isophthalic acid, terephthalic acid or hydroxyphthalic acid, anions of tri- or tetravalent carboxylic acids and mono-, di- or triesters thereof, such as hemimellitic acid, trimellitic acid, pyromellitic acid or citric acid, and furthermore so-called hyperbasic carboxylates, such as are described, for example, in DE-A 41 06 404 or DE-A 40 02 988, the disclosure of the last-mentioned documents being regarded as a constituent of the disclosure of the present text.

In the context of a preferred embodiment of the present invention, metal soaps, the anions of which are derived from saturated or unsaturated carboxylic acids or hydroxycarboxylic acids having about 8 to about 20 C atoms, are preferably employed. Stearates, oleates, laurates, palmitates, behenates, versatates, hydroxystearates, dihydroxystearates, p-tert-butylbenzoates or (iso)octanoates of calcium or zinc or mixtures of two or more of these are particularly preferred here. In the context of a further preferred embodiment of the present invention, a polymer composition according to the invention contains calcium stearate or zinc stearate or a mixture thereof.

A polymer composition according to the invention can contain the metal oxides, metal hydroxides or metal soaps mentioned or a mixture of two or more of these in an amount of up to about 5 wt. %, for example in an amount of from 0 to about 3 wt. %.

A polymer composition according to the invention can furthermore contain fillers such as are described in “Handbook of PVC Formulating”, E. J. Wickson, John Wiley & Sons, Inc., 1993, on pages 393-449, or reinforcing agents such as are described in “Taschenbuch der Kunststoffadditive [Handbook of Plastics Additives]”, R. Gächter/H. Müller, Carl Hanser Verlag, 1990, pages 549-615, or pigments.

A polymer composition according to the invention can moreover also contain impact modifiers and processing aids, gelling agents, further antistatics, biocides, metal deactivators, optical brighteners, flameproofing agents and antifogging compounds. Suitable compounds of these compound classes are described, for example, in “Kunststoff Additive [Plastics Additives]”, R. Keβler/H. Müller, Carl Hanser Verlag, 3rd edition, 1989 and in “Handbook of PVC Formulating”, E. J. Wilson, J. Wiley & Sons, 1993.

Examples of halogenated organic polymers which are correspondingly suitable as a constituent of a polymer composition according to the invention are polymers of vinyl chloride, vinyl resins which contain vinyl chloride units in the polymer backbone, copolymers of vinyl chloride and vinyl esters of aliphatic acids, in particular vinyl acetate, copolymers of vinyl chloride with esters of acrylic and methacrylic acid or acrylonitrile or mixture of two or more of these, copolymers of vinyl chloride with diene compounds or unsaturated dicarboxylic acids or anhydrides thereof, for example copolymers of vinyl chloride with diethyl maleate, diethyl fumarate or maleic anhydride, post-chlorinated polymers and copolymer of vinyl chloride, copolymers of vinyl chloride and vinylidene chloride with unsaturated aldehydes, ketones and other compounds, such as acrolein, crotonaldehyde, vinyl methyl ketone, vinyl methyl ether, vinyl isobutyl ether and the like, polymers and copolymers of vinylidene chloride with vinyl chloride and other polymerizable compounds, such as have already been mentioned above, polymers of vinyl chloroacetate and dichlorodivinyl ether, chlorinated polymers of vinyl acetate, chlorinated polymeric esters of acrylic acid and α-substituted acrylic acids, chlorinated polystyrenes, for example polydichlorostyrene, chlorinated polymers of ethylene, polymers and post-chlorinated polymers of chlorobutadiene and copolymers thereof with vinyl chloride, and mixtures of two or more of the polymers or polymer mixtures mentioned which contain one or more of the abovementioned polymers.

The graft polymers of PVC with EVA, ABS or MBS are likewise suitable as a constituent of the polymer compositions according to the invention. Preferred substrates for such graft copolymers are moreover the abovementioned homo- and copolymers, in particular mixtures of vinyl chloride homopolymers with other thermoplastic or elastomeric polymers, in particular blends with ABS, MBS, NBR, SAN, EVA, CPE, MBAS, PAA (polyalkyl acrylate), PAMA (polyalkyl methacrylate), EPDM, polyamides or polylactones.

Mixtures of halogenated and non-halogenated polymers, for example mixtures of the abovementioned non-halogenated polymers with PVC, in particular mixture of polyurethanes and PVC, are likewise suitable as a constituent of the polymer compositions according to the invention. With these also, in addition to the stabilizing an improvement in the discharge properties occurs.

According to the invention, recycled chlorinated polymers can furthermore also be stabilized and improved in their discharge properties, in principle all recycled abovementioned halogenated polymers being suitable for this. Recycled PVC, for example, is suitable in the context of the present invention.

However, the present invention moreover also relates to a stabilizer composition which contains at least one organic ammonium perchlorate, at least one amino alcohol having 2 to 12 carbon atoms in the alcohol radical and at least one additive. Suitable additives are the additives mentioned and expressly described as such in the context of the present text.

For a stabilizer composition according to the invention, the stated amounts given above apply in respect of its constituents, the amounts stated in each case being corrected by the content of polymer to be stabilized. Inasmuch as the present text therefore refers to a “polymer composition”, the statements made in this connection in respect of the constituents which are not be stabilized (stabilizer composition) also apply in their full scope to the present stabilizer composition, unless expressly stated otherwise.

In the context of a preferred embodiment of the present invention, a polymer composition according to the invention contains the stabilizer composition, which conventionally contributes towards improving the properties of a polymer during or after the processing, in an amount of from 0.1 to 20 phr, in particular about 0.5 to about 15 phr or about 1 to about 12 phr. In this context, values of at least 0.3 phr, such as at least about 0.4 or at least about 0.75 phr are preferred. The unit phr stands for “per hundred of resin” and thus relates to parts by weight per 100 parts by weight of polymer.

Preferably, a polymer composition according to the invention contains as the halogenated polymer at least a proportion of PVC, where the PVC content is, in particular, at least about 20, preferably at least about 50 wt. %, for example at least about 80 or at least about 90 wt. %.

The mixing of polymer or polymers and the stabilizer composition according to the invention can in principle be carried out at any desired point in time before or during the processing of the polymer. The polymer composition can thus be admixed, for example, to the polymer, which is in powder or granule form, before the processing. However, it is equally possible for the polymer composition to be added to the polymer or the polymers in the softened or molten state, for example during processing in an extruder.

A polymer composition according to the invention can be brought into a desired form in a known manner. Suitable processes are, for example, calendering, extrusion, injection moulding, sintering, extrusion blow-moulding or the plastisol process. A polymer composition according to the invention can also be used, for example, for the production of foams. The polymer compositions according to the invention are suitable in principle for the production of rigid or, in particular, plasticized PVC.

A polymer composition according to the invention can be processed to shaped articles. The present invention therefore also provides shaped articles containing at least one polymer composition according to the invention or a polymer composition according to the invention.

In the context of the present invention, the term “shaped article” in principle includes all three-dimensional structures which can be produced from a polymer composition according to the invention. In the context of the present invention, the term “shaped article” includes, for example, wire sheathings, automobile components, for example automobile components such as are employed in the interior of the automobile, in the engine space or on exterior surfaces, cable insulations, decorative films, agricultural films, hoses, sealing profiles, office films, hollow bodies (bottles), packaging films (thermoformed films), blown films, pipes, foams, heavy-duty profiles (window frames), luminous wall profiles, building profiles, sidings, fittings, sheets, foamed sheets, coextrudates with a recycled core, or housing for electrical equipment or machines, for example computers or domestic appliances. Further examples of shaped articles which can be produced from a polymer composition according to the invention are imitation leather, floor coverings, textile coatings, wallpaper, coil coatings or undersealing for motor vehicles.

The present invention likewise provides the use of a mixture of at least one organic ammonium salt of a perchlorate or a mixture of two or more organic ammonium salts of perchlorates and at least one amino alcohol having 2 to 12 C atoms in the alcohol radical or a mixture of two or more amino alcohols having 2 to 12 C atoms in the alcohol radical, wherein the melting point of the amino alcohol or of the mixture of two or more amino alcohols is 80° C. or less, as an antistatic.

In the context of a further embodiment of the present invention, in the context of the use according to the invention the amino alcohol is an alkanolamine. In the context of a further embodiment of the present invention, in the context of the use according to the invention the amino alcohol is an amino monoalcohol or an amino dialcohol or an amino trialcohol or a mixture of two or more of these. In the context of a further embodiment of the present invention, in the context of the use according to the invention the amino alcohol is a mono-amino alcohol.

The present invention likewise provides the use of a polymer composition according to the invention for the production of polymeric shaped articles or surface coating compositions.

The invention is explained in more detail in the following by examples.

To investigate the stabilizing properties, films which have the compositions as stated in Table 1 are first produced. In this context, film 1 was produced entirely without a stabilizer composition. Films 2 and 3 contained known stabilizer compositions based on sodium perchlorate, and the films 4, 5 and 6 according to the invention contained in each case another polymer composition according to the invention identified in Table 1. Of the samples 1 to 6 produced in this way, in each case three pieces of sample weighting 50±5 mg were subjected to a heat stability test in accordance with DIN VDE 0472 Part 614 at a test temperature of 200±0.5° C. in a metal block thermostat from Liebisch. The means calculated from the respective three individual values are likewise shown in Table 1. The discharge properties of samples 1 to 6 were investigated with the aid of an EMF 20 from the manufacturer Eltex. For the measurement, the PVC rolled sheet in 210×210 mm format which had been conditioned for one day at room temperature was clamped into the measuring apparatus and provided with a static charge of 10 kV.

The time taken for 50% discharge was then measured and recorded,

TABLE 1

| | Commercial/ | | | | | | |
|---|---|---|---|---|---|---|---|
| Constituent | trivial name | 1 | 2 | 3 | 4 | 5 | 6 |
| PVC | Vinnolit S 4170 | 100 | 100 | 100 | 100 | 100 | 100 |
| Plasticizer (diisononyl | Palatinol N | 40 | 40 | 40 | 40 | 40 | 40 |
| phthalate, DINP) | | | | | | | |
| Mixture 1) (see below) | | 2 | 2 | 2 | 2 | 2 | 2 |
| NaClO₄ (10 wt. %) on Ca | | | 1 | | | | |
| silicate | | | | | | | |
| NaClO₄ in dibutylene | | | | 1 | | | |
| glycol (35 wt. % strength) | | | | | | | |
| TEA * ClO₄ (20 wt. % | | | | | 1 | | |
| strength in TEA) | | | | | | | |
| (according to the invention) | | | | | | | |
| TiPA * ClO₄ (20 wt. % | | | | | | 1 | |
| strength in TEA) | | | | | | | |
| (according to the invention) | | | | | | | |
| TiPa * ClO₄ (20 wt. % | | | | | | | 1 |
| strength in TiPA) | | | | | | | |
| (according to the invention) | | | | | | | |
| Heat stability [min]: | | 12 | 17 | 8 | 23 | 16 | 17 |
| Discharge [s]: | | 3.4 | 0.2 | 0.1 | 0.2 | 0.1 | 0.2 |

1) Butylene diglycol 19%, nonylphenol butyldiglycol phosphite 50%, bisphenol A 2%, dibenzoylmethane 2%, Ca soaps 17%, Zn soaps 10% - all data are data in wt. %.

In the case of sample 2, a significant clouding was already to be seen after production of the film.

1. A polymer composition, comprising:
a) at least one halogenated polymer;
b) at least one organic ammonium salt of a perchlorate or a mixture of two or more organic ammonium salts of perchlorates; and
c) at least one amino alcohol having 2 to 12 C atoms in the alcohol radical, wherein the melting point of the amino alcohol is 80° C. or less.

2. The polymer composition according to claim 1, wherein the amino alcohol is an alkanolamine.

3. The polymer composition according to claim 1, wherein the amino alcohol comprises one or more amino alcohols selected from the group consisting of amino monoalcohols, amino dialcohols and amino trialcohols.

4. The polymer composition according to claim 1, wherein the amino alcohol includes a mono-amino alcohol.

5. The polymer composition according to claim 1, wherein the polymer composition comprises 0.01 to 5 wt. % of the at least one organic ammonium salt of a perchlorate or of the mixture of two or more organic ammonium salts of perchlorates.

6. The polymer composition according to claim 1, wherein the polymer composition comprises 0.05 to 3 wt. % of the at least one organic ammonium salt of a perchlorate or of the mixture of two or more organic ammonium salts of perchlorates.

7. A method of preparing a polymeric shaped article, comprising mixing at least one halogenated polymer with an antistatic comprising a mixture of at least one organic ammonium salt of a perchlorate or a mixture of two or more organic ammonium salts of perchlorates and at least one amino alcohol having 2 to 12 C atoms in the alcohol radical, wherein the melting point of the at least one amino alcohol is 80° C. or less.

8. The method according to claim 7, wherein the amino alcohol includes an alkanolamine.

9. The method according to of claim 7, wherein the amino alcohol comprises one or more amino alcohols selected from the group consisting of amino monoalcohols, an amino dialcohols and amino trialcohols.

10. The method according to claim 7, wherein the amino alcohol includes a mono-amino alcohol.

11. (canceled)

12. A stabilizer composition comprising at least one organic ammonium perchlorate, at least one amino alcohol having 2 to 12 carbon atoms in the alcohol radical and at least one further additive.

13. A method of preparing an antistatic coating for a surface, comprising applying to the surface a coating composition comprising at least one halogenated polymer; at least one organic ammonium salt of a perchlorate or a mixture of two or more organic ammonium salts of perchlorates; and at least one amino alcohol having 2 to 12 C atoms in the alcohol radical, wherein the melting point of the amino alcohol is 80° C. or less.
